(19) United States
(12) Patent Application Publication
(10) Pub. No.: US 2023/0048191 A1
(43) Pub. Date: Feb. 16, 2023

(54) BATTERY CELL BALANCE CIRCUIT AND METHOD OF OPERATING THE SAME

(71) Applicant: DELTA ELECTRONICS, INC., Taoyuan City (TW)

(72) Inventors: Sheng-Hua LI, Taoyuan City (TW); Hung-Chang WANG, Taoyuan City (TW); Tsu-Hua AI, Taoyuan City (TW)

(21) Appl. No.: 17/751,414

(22) Filed: May 23, 2022

Related U.S. Application Data
(60) Provisional application No. 63/232,925, filed on Aug. 13, 2021.

(30) Foreign Application Priority Data
Dec. 22, 2021 (CN) 202111579357.6

(51) Int. Cl. H02J 7/00; H02M 3/158

(52) U.S. Cl. CPC H02J 7/0016; H02J 7/0019; H02J 7/0047; H02J 7/00304; H02M 3/158

(57) ABSTRACT

A battery cell balance circuit includes an AC/DC converter, a plurality of battery cells, a plurality of switches, an isolated DC/DC converter, a circuit switch, and a control unit. The AC/DC converter receives an AC power. The battery cells are connected in series to form a battery link. Each switch is correspondingly connected to one battery cell. The isolated DC/DC converter is coupled to the switches and coupled to the battery link in series. The circuit switch is coupled between the AC/DC converter, the isolated DC/DC converter, and the plurality of switches. The control unit provides a plurality of control signals to correspondingly control the plurality of switches and the circuit switch.

### CROSS-REFERENCE TO RELATED APPLICATION

This patent application claims the benefit of U.S. Provisional Patent Application No. 63/232,925, filed Aug. 13, 2021, which is incorporated by reference herein.

### BACKGROUND

### Technical Field

The present disclosure relates to a battery cell balance circuit and a method of operating the same, and more particularly to an active battery cell balance circuit and a method of operating the same.

### Description of Related Art

The statements in this section merely provide background information related to the present disclosure and do not necessarily constitute prior art.

In the application of high-energy (high-power), high-voltage energy storage system, it is usually not operated by a single battery. In other words, in order to achieve high-energy (high-power) and high-voltage energy storage applications, the packaging of multiple battery cells will be modularized. FIG. 1 shows a perspective diagram of a battery module having a plurality of battery cells in the related art. Each battery module 100 has 18 battery cells 101-10N arranged in two rows and connected in series. Therefore, in the application of the energy storage system, parallel connection can be provided through multiple groups of battery modules 100 at the same time so as to achieve high-energy (high-power) and high-voltage power supply applications.

For a single battery cell 101-10N, when the battery cell 101-10N ages, abnormal phenomena such as easy to be fully charged and easy to discharge will occur. For the single battery module 100 shown in FIG. 1, it has 18 battery cells 101-10N. Once one of the battery cells ages in advance, the effect of charging and discharging of the more seriously aged battery cell on the other 17 battery cells will lie in: during charging, the charging voltage of the more seriously aged battery cell rapidly rises. Therefore, for the overall battery module 100, during the normal charging process, the more seriously aged battery cell may be over-charged (other battery cells may not be fully charged), or even damaged. Conversely, during discharging, the voltage of the more seriously aged battery cell rapidly drops. Therefore, for the overall battery module 100, during the normal discharging process, the more seriously aged battery cell may be over-discharged (other battery cells may not be fully discharged), or even damaged.

### SUMMARY

An object of the present disclosure is to provide a battery cell balance circuit to solve the problems of existing technology.

In order to achieve the above-mentioned object, the battery cell balance circuit includes an AC/DC converter, a plurality of battery cells, a plurality of switches, an isolated DC/DC converter, a circuit switch, and a control unit. The AC/DC converter receives an AC power and convert the AC power into a DC power. The battery cells are connected in series to form a battery link. Each of the switches is correspondingly connected to each of the battery cells. An input side of the isolated DC/DC converter is coupled in parallel to an input side of each of the switches, and an output side of the isolated DC/DC converter is coupled to the battery link. The circuit switch is coupled between the AC/DC converter, the isolated DC/DC converter, and the plurality of switches. The control unit provides a plurality of control signals to correspondingly control the plurality of switches and the circuit switch.

Another object of the present disclosure is to provide a method of operating a battery cell balance circuit to solve the problems of existing technology.

In order to achieve the above-mentioned object, the battery cell balance circuit includes a plurality of battery cells connected in series to form a battery link, a plurality of switches, each of the switches correspondingly connected to each of the battery cells, and a circuit switch coupled between a DC power and the switches. The method includes steps of: controlling the switch corresponding to the battery cell to be turned on when a battery voltage of any one of the battery cells is detected to be greater than an upper threshold voltage, releasing electrical energy of the battery cell to the battery link, controlling the circuit switch to be turned on and controlling the switch corresponding to the battery cell to be turned on when the battery voltage of any one of the battery cells is detected to be less than a lower threshold voltage, and receiving, by the battery cell, the electrical energy from the DC power.

Accordingly, the battery voltage is adjusted through the release and supplement of electrical energy for the more seriously aged battery cells, that is, when the battery voltage of the battery cell is too high, the electrical energy is transmitted to the battery link, and when the battery voltage of the battery cell is too low, the electrical energy is supplemented by the AC power. Therefore, the battery voltage of the more severely aged battery cells during the charging and discharging processes can be maintained to be approximately the same as the battery voltage of other battery cells so as to ensure the normal operation of the overall battery module. Accordingly, in the application of the energy storage system, the operation of the battery module can be continuously maintained without requiring frequent replacement of battery cells. Until the annual repair, the seriously aged battery cells will be replaced in order to improve the economic benefits of the application of the energy storage system.

It is to be understood that both the foregoing general description and the following detailed description are exemplary, and are intended to provide further explanation of the present disclosure as claimed. Other advantages and features of the present disclosure will be apparent from the following description, drawings, and claims.

### BRIEF DESCRIPTION OF DRAWINGS

The present disclosure can be more fully understood by reading the following detailed description of the embodiment, with reference made to the accompanying drawing as follows:

FIG. 1 is a perspective diagram of a battery module having a plurality of battery cells in the related art.

FIG. 2 is a block circuit diagram of a switch unit of a battery cell balance circuit according to a first embodiment of the present disclosure.

FIG. 3 is a block circuit diagram of the switch unit of the battery cell balance circuit according to a second embodiment of the present disclosure.

FIG. 4 is a block circuit diagram of the switch unit of the battery cell balance circuit according to a third embodiment of the present disclosure.

FIG. 5 is a block circuit diagram of the battery cell balance circuit according to a preferred embodiment of the present disclosure.

FIG. 6 is a detailed block circuit diagram of the battery cell balance circuit according to the preferred embodiment of the present disclosure.

FIG. 7 is a flowchart of a method of operating the battery cell balance circuit according to the present disclosure.

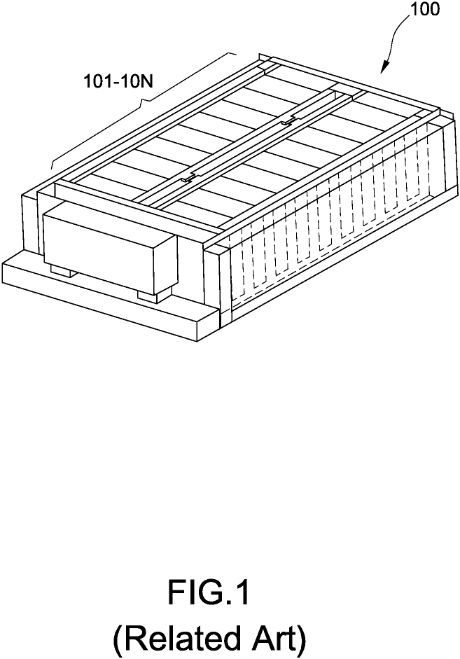

### DETAILED DESCRIPTION

Reference will now be made to the drawing figures to describe the present disclosure in detail. It will be understood that the drawing figures and exemplified embodiments of present disclosure are not limited to the details thereof.

Before describing the technical features of the battery cell balance circuit and the method of operating the same in detail, the passive battery cell balance technology and the active battery cell balance technology are briefly described. The passive battery cell balance technology refers to the energy consumption of battery cells with higher voltage through energy-consuming components. The common practice is: each battery cell is connected in parallel with resistance components through the switch circuit, and the energy of the battery cells with higher voltage is consumed by controlling the conduction (turned-on) of the switch and the parallel resistance components, thereby reducing the battery voltage of the battery cells to achieve a voltage balance between the battery cells.

In comparison with the passive battery cell balance technology, the active battery cell balance technology refers to the redistribution of energy between cells. For example, using energy storage components (such as inductors or capacitors) to temporarily store the energy of the battery cells with higher voltage, and then release the temporarily stored energy to the battery cells with lower voltage to achieve the effect of voltage balance between the battery cells.

However, in comparison with the existing active battery cell balance technology disclosed above, the present disclosure proposes different technical means to achieve the effect of active battery cell balance.

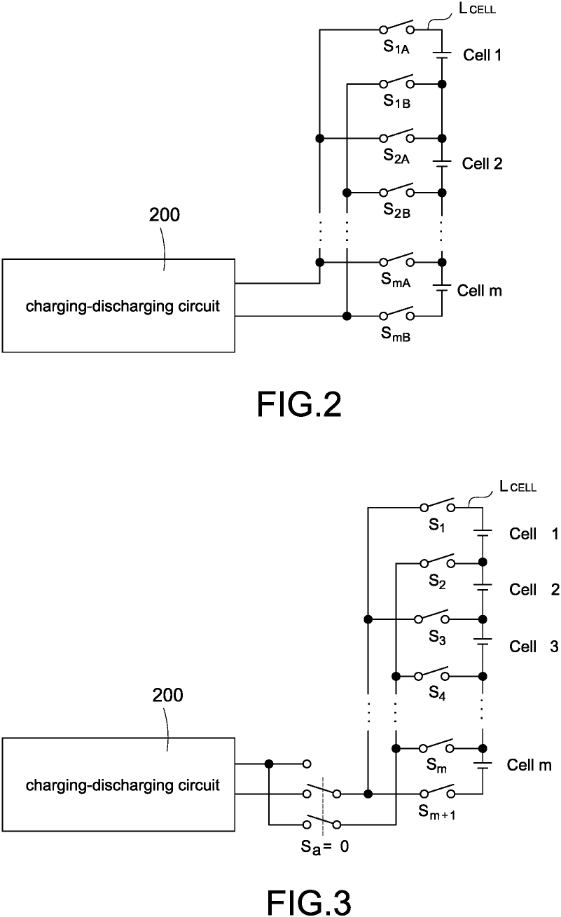

Please refer to FIG. 2, which shows a block circuit diagram of a switch unit of a battery cell balance circuit according to a first embodiment of the present disclosure. In FIG. 2, the battery cell balance circuit includes a plurality of (m) battery cells Cell 1-Cell m, and the battery cells Cell 1-Cell m are connected in series to form a battery link L_{CELL}. In the configuration structure of this embodiment, since a positive end and a negative end of each battery cell Cell 1-Cell m are respectively connected to a switch unit, that is, a positive end of a first battery cell Cell 1 is connected to a switch unit S_{1A} and a negative end of the first battery cell Cell 1 is connected to a switch unit S_{1B}, and a positive end of a second battery cell Cell 2 is connected to a switch unit S_{2A} and a negative end of the second battery cell Cell 2 is connected to a switch unit S_{2B}, and so on, the number of switch units is twice the number of battery cells. For example, if the number of the battery cells Cell 1-Cell m is 18, the number of the switch units is 36. In FIG. 2, the battery cells Cell 1-Cell m are connected to a charging-discharging circuit 200. In particular, positive ends of the battery cells Cell 1-Cell m are respectively connected to positive supplying ends or positive receiving ends of the charging-discharging circuit 200 through the switch units S_{1A}-S_{mA}. Similarly, negative ends of the battery cells Cell 1-Cell m are respectively connected to negative supplying ends or negative receiving ends of the charging-discharging circuit 200 through the switch units S_{1B}-S_{mB}.

Incidentally, the charging-discharging circuit 200 shown in FIG. 2 is used to provide a charging operation when a voltage of the battery cells Cell 1-Cell m (at least one of them) is too low to be charged, or a discharging operation when the voltage is too high to be discharged. That is, the charging-discharging circuit 200 may be, for example, but not limited to, a circuit having both charging and discharging functions, or two sets of circuits with separate charging and discharging functions.

Please refer to FIG. 3, which shows a block circuit diagram of the switch unit of the battery cell balance circuit according to a second embodiment of the present disclosure. In FIG. 3, the battery cell balance circuit includes a plurality of (m) battery cells Cell 1-Cell m, and the battery cells Cell 1-Cell m are connected in series to form a battery link L_{CELL}. In the configuration structure of this embodiment, since a positive end of the first battery cell Cell 1 is connected to a switch unit S₁, a negative end of the last battery cell Cell m is connected to a switch unit Sₘ₊₁, and the positive end and the negative end of the middle (the remaining) battery cells Cell 2 to Cell m-1 jointly connected to a switch unit S₂-Sₘ. Furthermore, a switch assembly Sa composed of four switch units (described in detail later), the charging and discharging operations of the battery cells Cell 1-Cell m are realized. Therefore, the number of the switch units is five more than the number of the battery cells. For example, if the number of the battery cells Cell 1-Cell m is 18, the number of the switch units is 23.

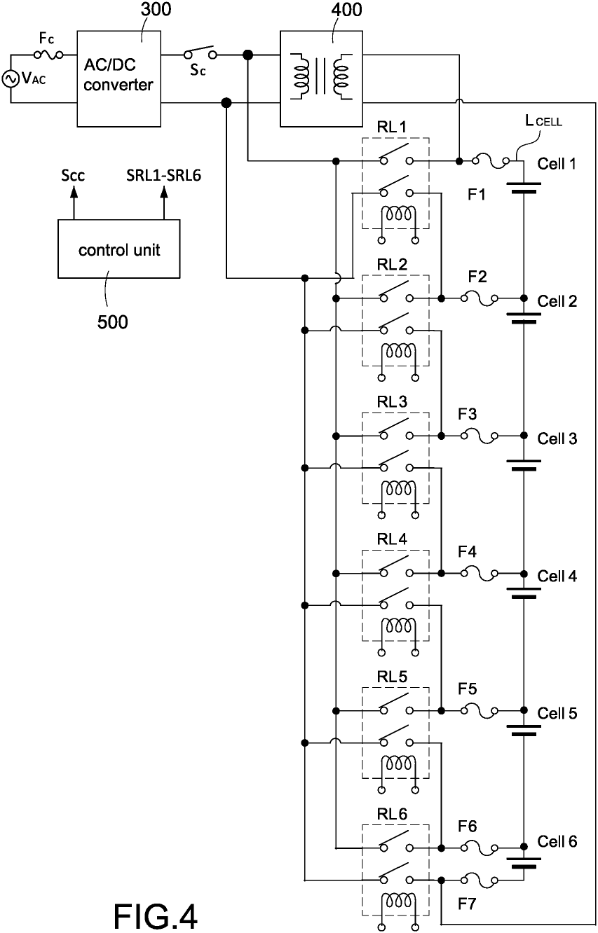

Please refer to FIG. 4, which shows a block circuit diagram of the switch unit of the battery cell balance circuit according to a third embodiment of the present disclosure. Compared with the previous embodiments of FIG. 2 and FIG. 3, the switch units shown in FIG. 4 are realized by electromagnetic relays RL1-RL6 (take the battery link L_{CELL} with 6 battery cells as an example). In other words, the excitation control of the electromagnetic relays RL1-RL6 is used so that the effect of turning on and turning off is implemented, and a path for charging and discharging operations of the battery cells Cell 1-Cell 6 is provided.

Specifically, take the embodiment of FIG. 4 as an example, the battery cell balance circuit mainly includes an AC/DC converter 300, a plurality of battery cells Cell 1-Cell 6, a plurality of switch units RL1-RL6, an isolated DC/DC converter 400, a control unit 500. The AC/DC converter 300 receives an AC power V_{AC}, and converts the AC power V_{AC} into a DC power. The battery cells Cell 1-Cell 6 are connected in series to form a battery link L_{CELL}. Each of the switch units RL1-RL6 is correspondingly connected to each of the battery cells Cell 1-Cell 6. In the embodiment shown in FIG. 4, each switch unit RL1 - RL6 is an electromagnetic relay, which uses the principle of electromagnetic effect to excite the coil to change states of the contact to implement the turned-on and the turned-off function. Moreover, the number of switch units RL1-RL6 is the same as that of battery cells Cell 1-Cell 6, that is, the first battery cell Cell 1 is connected to the first switch unit RL1, the second battery cell Cell 2 is connected to the second switch unit RL2, and so on.

An input side of the isolated DC/DC converter 400 is coupled in parallel to an input side of each of the switches RL1-RL6. Specifically, the input side of the isolated DC/DC converter 400 has a positive end and a negative end, and the positive end is connected to a positive end of the DC power converted from the AC/DC converter 300 and the negative end is connected to a negative end of the DC power. Each electromagnetic relay has a first side and a second side, and the first side and the second side have a positive end and a negative end, respectively. The positive end of the first side is coupled to the positive end of the DC power and the positive end of the input side of the isolated DC/DC converter 400, the negative end of the first side is coupled to the negative end of the DC power and the negative end of the input side of the isolated DC/DC converter 400, and the positive end and the negative end of the second side are correspondingly connected to the positive ends and the negative ends of the battery cells, respectively. In other words, the positive ends of the first sides of all the electromagnetic relays are jointly coupled, and then coupled to the positive end of the DC power and the positive end of the input side of the isolated DC/DC converter 400. Similarly, the negative ends of the first sides of all the electromagnetic relays are jointly coupled, and then coupled to the negative end of the DC power and the negative end of the input side of the isolated DC/DC converter 400.

Moreover, an output side of the isolated DC/DC converter 400 is coupled in series to the battery link L_{CELL}. The output side of the isolated DC/DC converter 400 has a positive end and a negative end, and the positive end is coupled to a positive end of the battery link L_{CELL} (i.e., a positive end of the first battery cell Cell 1) and the negative end is coupled to a negative end of the battery link L_{CELL} (i.e., a negative end of the sixth battery cell Cell 6) so that the output side of the isolated DC/DC converter 400 is coupled in series to the battery link L_{CELL}.

The circuit switch Sc is coupled between the AC/DC converter 300 and the isolated DC/DC converter 400, that is, between the AC/DC converter 300 and the switch units RL1-RL6. In one embodiment, the circuit switch Sc may be, for example, but not limited to, an electromagnetic relay or a transistor switch, such as a MOSFET.

During the charging process of the plurality of battery cells Cell 1-Cell 6, if all battery cells Cell 1-Cell 6 are normal, the battery voltages of all battery cells Cell 1-Cell 6 will not be abnormally high when fully charged. Similarly, during the discharging process of the plurality of battery cells Cell 1-Cell 6, if all battery cells Cell 1-Cell 6 are normal, the battery voltages of all battery cells Cell 1-Cell 6 will not be abnormally low when fully discharged.

Once the battery voltage of any one of the battery cells Cell 1-Cell 6 is too high (abnormally high) during the charging process, the electrical energy of the battery cell with the too-high battery voltage is released to the battery link L_{CELL} so that battery voltage of the battery cell is reduced and the battery cell is not over charged. In addition, once the battery voltage of any one of the battery cells Cell 1-Cell 6 is too low (abnormally low) during the discharging process, the AC power V_{AC} provides electrical energy to the battery cell with the too-low battery voltage so that the battery voltage of the battery cell is increased and the battery cell is not over discharged.

Specifically, during the charging process of the battery cells Cell 1-Cell 6, when the control unit 500 detects that a battery voltage of any one of the battery cells Cell 1-Cell 6 is greater than the upper threshold voltage, the control unit 500 provides switch control signals SRL1-SRL6 to turn on the switch unit RL1-RL6 corresponding to the battery cell with the too-high battery voltage so that the electrical energy of the battery cell Cell 1-Cell 6 with the too-high battery voltage is released to the battery link L_{CELL} through the isolated DC/DC converter 400. For example, when the control unit 500 detects that the battery voltage of the first battery cell Cell 1 is too high (i.e., the battery voltage is greater than the upper threshold voltage), the control unit 500 turns on the first switch unit RL1 by the first switch control signal SRL1 so that the electrical energy of the first battery cell is released to the battery link L_{CELL} through the first switch unit RL1 and the isolated DC/DC converter 400. In addition to reducing the battery voltage of the first battery cell Cell 1 to prevent over-charging, the electrical energy of the first battery cell Cell 1 can also be used as the electrical energy for charging the battery link L_{CELL} without wasting. Similarly, the operation principles of other battery cells are the same as those described above, and the detail description is omitted here for conciseness.

During the discharging process of the battery cells Cell 1-Cell 6, when the control unit 500 detects that a battery voltage of any one of the battery cells Cell 1-Cell 6 is less than the lower threshold voltage, the control unit 500 provides a switch control signal S_{CC} to turn on the circuit switch Sc, and provides switch control signals SRL1-SRL6 to turn on the switch unit RL1-RL6 corresponding to the battery cell with the too-low battery voltage so that the battery cell Cell 1-Cell 6 with the too-low battery voltage receives electrical energy provided from the AC power V_{AC}. In particular, the lower threshold voltage is less than the upper threshold voltage. For example, when the control unit 500 detects that the battery voltage of the first battery cell Cell 1 is too low (i.e., the battery voltage is less than the lower threshold voltage), the control unit 500 turns on the circuit switch Sc by the switch control signal S_{CC}, and turns on the first switch unit RL1 by the first switch control signal SRL1 so that the AC power V_{AC} supplies power to the first battery cell Cell 1 (i.e., provides the electrical energy to the first battery cell Cell 1) through the circuit switch Sc and the first switch unit RL1, thereby increasing the battery voltage of the first battery cell Cell 1 to prevent over-discharging. Similarly, the operation principles of other battery cells are the same as those described above, and the detail description is omitted here for conciseness.

Accordingly, the battery voltage is adjusted through the release and supplement of electrical energy for the more seriously aged battery cells, that is, when the battery voltage of the battery cell is too high, the electrical energy is transmitted to the battery link, and when the battery voltage of the battery cell is too low, the electrical energy is supplemented by the AC power. Therefore, the battery voltage of the more severely aged battery cells during the charging and discharging processes can be maintained to be approximately the same as the battery voltage of other battery cells so as to ensure the normal operation of the overall battery module. Accordingly, in the application of the energy storage system, the operation of the battery module can be continuously maintained without requiring frequent replacement of battery cells. Until the annual repair, the seriously aged battery cells will be replaced in order to improve the economic benefits of the application of the energy storage system.

Please refer to FIG. 4 again, the battery cell balance circuit further includes a plurality of over-current protection components correspondingly coupled to the battery cells Cell 1-Cell 6. In one embodiment, the over-current protection components are fuses F1-F7. During the charging and discharging process, if an overcurrent abnormality occurs, an overcurrent protection can be provided through the corresponding fuses F1-F7 to protect the battery cells Cell 1-Cell 6.

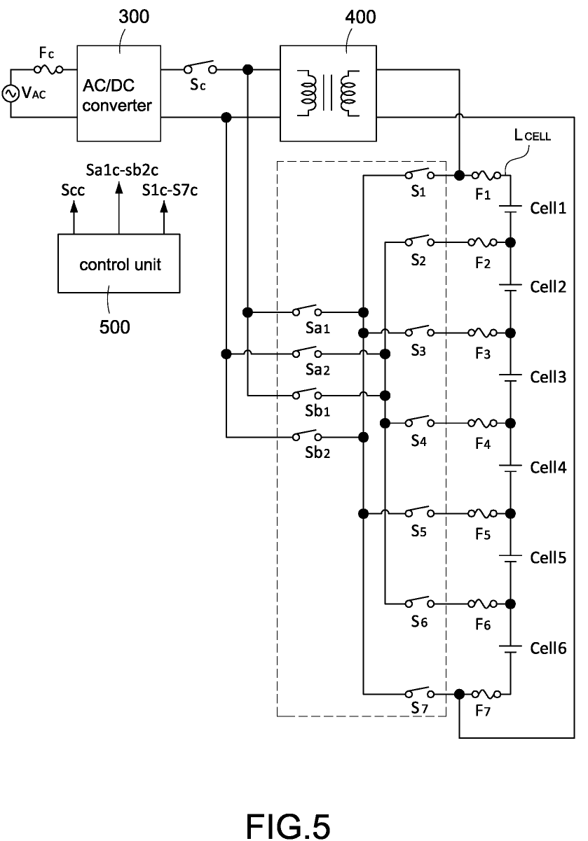

Please refer to FIG. 5, which shows a block circuit diagram of the battery cell balance circuit according to a preferred embodiment of the present disclosure, and the FIG. 5 is cooperated with the embodiment shown in FIG. 3 (i.e., the second embodiment of the switch unit). Take the battery link L_{CELL} with 6 battery cells as an example, the battery cell balance circuit mainly includes an AC/DC converter 300, an isolated DC/DC converter 400, a control unit 500, a plurality of (6) battery cells Cell 1-Cell 6 (connected in series to form a battery link L_{CELL}), a plurality of (7) switch units S₁-S₇, and a switch assembly Sa having a plurality of switch units Sa1, Sa2, Sb1, Sb2. The control unit 500 provides switch control signals S1c-S7c to correspondingly control the switch units S₁-S₇, provides switching switch control signals Salc-Sb2c to correspondingly control the switch units Sa1, Sa2, Sb1, Sb2, and provides a switch control signal S_{CC} to control the circuit switch Sc. In this embodiment, due to the configuration design (connection relationship) of the switch units S₁-S₇, for a battery module with more battery cells, the number of switch units may be significantly reduced (as described in FIG. 3 above). Therefore, with the turning on and turning off the switch units Sa1, Sa2, Sb1, Sb2, a path for providing the charging and discharging operations of the battery cells Cell 1-Cell 6 can be implemented.

Specifically, during the charging process of the battery cells Cell 1-Cell 6, when the control unit 500 detects that a battery voltage of any one of the battery cells Cell 1-Cell 6 is greater than the upper threshold voltage, the control unit 500 provides switch control signals S1c-S7c to turn on the switch unit S₁-S₇ corresponding to the battery cell with the too-high battery voltage so that the electrical energy of the battery cell Cell 1-Cell 6 with the too-high battery voltage is released to the battery link L_{CELL} through the isolated DC/DC converter 400. For example, when the control unit 500 detects that the battery voltage of the first battery cell Cell 1 is too high (i.e., the battery voltage is greater than the upper threshold voltage), the control unit 500 turns on the first switching switch unit Sa1 by the first switching switch control signal Sa1c, turns on the second switching switch unit Sa2 by the second switching switch control signals Sa2c, turns on the first switch unit S₁ by the first switch control signal S1c, and turns on the second switch unit S₂ by the second switch control signal S2c so that the electrical energy of the first battery cell is released to the battery link L_{CELL} through the first switch unit S₁, the second switch unit S₂, the first switching switch unit Sa1, the second switching switch unit Sa2, and the isolated DC/DC converter 400. In addition to reducing the battery voltage of the first battery cell Cell 1 to prevent over-charging, the electrical energy of the first battery cell Cell 1 can also be used as the electrical energy for charging the battery link L_{CELL} without wasting.

For example, when the control unit 500 detects that the battery voltage of the second battery cell Cell 2 is too high (i.e., the battery voltage is greater than the upper threshold voltage), the control unit 500 turns on the third switching switch unit Sb1 by the third switching switch control signal Sb1c, turns on the fourth switching switch unit Sb2 by the fourth switching switch control signals Sb2c, turns on the second switch unit S₂ by the second switch control signal S2c, and turns on the third switch unit S₃ by the third switch control signal S3c so that the electrical energy of the second battery cell is released to the battery link L_{CELL} through the second switch unit S₂, the third switch unit S₃, the third switching switch unit Sb1, the fourth switching switch unit Sb2, and the isolated DC/DC converter 400. In addition to reducing the battery voltage of the second battery cell Cell 2 to prevent over-charging, the electrical energy of the second battery cell Cell 2 can also be used as the electrical energy for charging the battery link L_{CELL} without wasting.

During the discharging process of the battery cells Cell 1-Cell 6, when the control unit 500 detects that a battery voltage of any one of the battery cells Cell 1-Cell 6 is less than the lower threshold voltage, the control unit 500 provides a switch control signal S_{CC} to turn on the circuit switch Sc, and provides switch control signals S1c-S7c to turn on the switch unit S₁-S₇ corresponding to the battery cell with the too-low battery voltage so that the battery cell Cell 1-Cell 6 with the too-low battery voltage receives electrical energy provided from the AC power V_{AC}. For example, when the control unit 500 detects that the battery voltage of the first battery cell Cell 1 is too low (i.e., the battery voltage is less than the lower threshold voltage), the control unit 500 turns on the circuit switch Sc by the switch control signal S_{CC}, turns on the first switching switch unit Sa1 by the first switching switch control signal Sa1c, turns on the second switching switch unit Sa2 by the second switching switch control signal Sa2c, turns on the first switch unit S₁ by the first switch control signal S1c, and turns on the second switch unit S₂ by the second switch control signal S2c so that the AC power V_{AC} supplies power to the first battery cell Cell 1 (i.e., provides the electrical energy to the first battery cell Cell 1) through the circuit switch S_{C}, the first switching switch unit Sa1, the second switching switch unit Sa2, the first switch unit S₁, and the second switch unit S₂, thereby increasing the battery voltage of the first battery cell Cell 1 to prevent over-discharging.

For example, when the control unit 500 detects that the battery voltage of the second battery cell Cell 2 is too low (i.e., the battery voltage is less than the lower threshold voltage), the control unit 500 turns on the circuit switch S_{C} by the switch control signal S_{CC}, turns on the third switching switch unit Sb1 by the third switching switch control signal Sb1c, turns on the fourth switching switch unit Sb2 by the fourth switching switch control signal Sb2c, turns on the second switch unit S₂ by the second switch control signal S2c, and turns on the third switch unit S₃ by the third switch control signal S3c so that the AC power V_{AC} supplies power to the second battery cell Cell 2 (i.e., provides the electrical energy to the second battery cell Cell 2) through the circuit switch S_{C}, the third switching switch unit Sb1, the fourth switching switch unit Sb2, the second switch unit S₂, and the third switch unit S₃, thereby increasing the battery voltage of the second battery cell Cell 2 to prevent over-discharging.

Accordingly, the control principle of the switch assembly Sa (including switching switch units Sa1,Sa2,Sb1,Sb2) and the switch units S₁-S₇ of the battery cell balance circuit shown in FIG. 5 is: according to the positive end and the negative end of the DC power converted and outputted by the AC/DC converter 300, the positive end and the negative end of the battery cells Cell 1-Cell 6 with the too-high battery voltage (or too-low battery voltage) are consistent so as to implement the adjustment of the battery voltage through the energy release and energy replenishment for the seriously aged battery cells.

Similarly, the first embodiment of the switch unit shown in FIG. 2 may also be applied to the structure of FIG. 5, and the control principle of the switch unit is similar to that of FIG. 5, and the detail description is omitted here for conciseness.

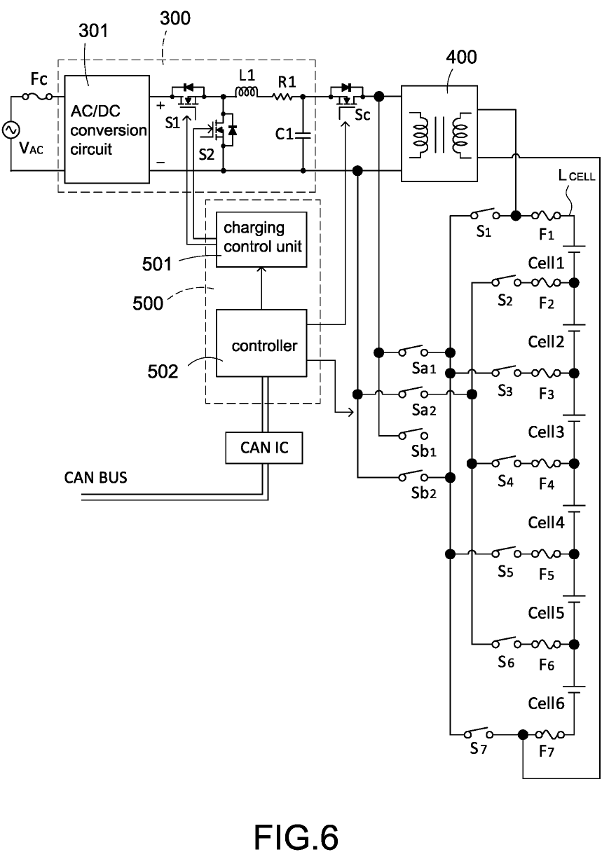

Please refer to FIG. 6, which shows a detailed block circuit diagram of the battery cell balance circuit according to the preferred embodiment of the present disclosure. The FIG. 6 more specifically discloses that the AC/DC converter 300 includes an AC/DC conversion circuit 301 and a non-isolated DC/DC conversion. In this embodiment, the non-isolated DC/DC conversion circuit is a step-down conversion circuit, which includes a switch S1, a switch S2, an inductor L1, a capacitor C1, and a resistor R1. The control unit 500 includes a charging control unit 501 and a controller 502 for controlling charging and discharging operations of the battery cells Cell 1-Cell 6. Moreover, the battery cell balance circuit further includes a controller area network (CAN) involving a CAN IC and CAN bus. Therefore, the results of the detection and control of overall circuit by the control unit 500 are transmitted to the outside (external system) through the CAN so as to facilitate remote operators to acquire monitoring and control, thereby performing maintenance immediately to maintain the normal operation of the system.

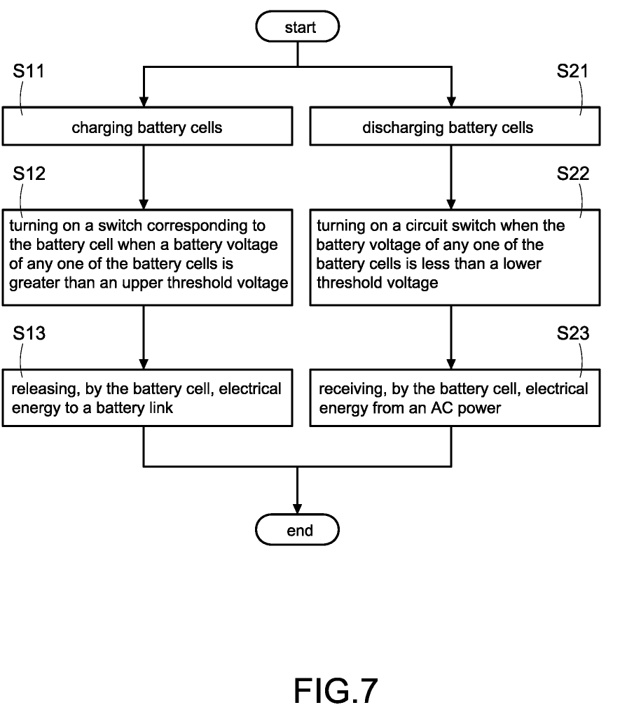

Please refer to FIG. 7, which shows a flowchart of a method of operating the battery cell balance circuit according to the present disclosure. The battery cell balance circuit includes a plurality of battery cells connected in series to form a battery link, a plurality of switches, each of the switches correspondingly connected to each of the battery cells, and a circuit switch coupled between a DC power and the switches. The specific structure of the battery cell balance circuit may be found in the previous disclosure, and the detail description is omitted here for conciseness. The method of operating the battery cell balance circuit of the present disclosure includes steps of: charging the battery cells (S11) and discharging the battery cells (S21). When a battery voltage of any one of the battery cells is detected to be greater than an upper threshold voltage during the charging of the battery cells, controlling the switch corresponding to the battery cell to be turned on (S12). Furthermore, releasing electrical energy of the battery cell to the battery link (S13). When a battery voltage of any one of the battery cells is detected to be less than a lower threshold voltage during the discharging of the battery cells, controlling the circuit switch to be turned on, and controlling the switch corresponding to the battery cell to be turned on (S22). Moreover, the battery cell receives the electrical energy provided from the AC power (S23).

In summary, the advantages and features of the present disclosure are:
1. The battery cell balance circuit of the present disclosure adjusts the battery voltage through the release and supplement of electrical energy for the more seriously aged battery cells. That is, when the battery voltage of the battery cell is too high, the electrical energy is transmitted to the battery link, and when the battery voltage of the battery cell is too low, the electrical energy is supplemented by the AC power. Therefore, the battery voltage of the more severely aged battery cells during the charging and discharging processes can be maintained to be approximately the same as the battery voltage of other battery cells so as to ensure the normal operation of the overall battery module. Accordingly, in the application of the energy storage system, the operation of the battery module can be continuously maintained without requiring frequent replacement of battery cells. Until the annual repair, the seriously aged battery cells will be replaced in order to improve the economic benefits of the application of the energy storage system.
2. The selected battery modules are coupled to the battery cell balance circuit through solid state switches. In such circuit configuration, switches can use solid state switches instead of double pole single throw switches (traditional solenoid valve switches), thereby increasing switch life in battery cell balance circuit and optimizing voltage differences between battery modules.
3. For battery link charging: select the battery cell with the highest battery voltage, recover its energy, and feed it back to the battery link to extend the charging time of the battery link.
4. For battery link discharging: select the battery cell with the lowest battery voltage, and charge it from the AC power to extended the discharging time of the battery link.

Although the present disclosure has been described with reference to the preferred embodiment thereof, it will be understood that the present disclosure is not limited to the details thereof. Various substitutions and modifications have been suggested in the foregoing description, and others will occur to those of ordinary skill in the art. Therefore, all such substitutions and modifications are intended to be embraced within the scope of the present disclosure as defined in the appended claims.

What is claimed is:

1. A battery cell balance circuit, comprising:
an AC/DC converter, configured to receive an AC power and convert the AC power into a DC power,
a plurality of battery cells, connected in series to form a battery link,
a plurality of switches, each of the switches correspondingly connected to each of the battery cells,
an isolated DC/DC converter, an input side of the isolated DC/DC converter coupled in parallel to an input side of each of the switches, and an output side of the isolated DC/DC converter coupled to the battery link,
a circuit switch, coupled between the AC/DC converter, the isolated DC/DC converter, and the plurality of switches, and
a control unit, configured to provide a plurality of control signals to correspondingly control the plurality of switches and the circuit switch.

2. The battery cell balance circuit as claimed in claim 1, wherein when the control unit detects a battery voltage of any one of the battery cells is greater than an upper threshold voltage, the control unit turns on the switch corresponding to the battery cell so that electrical energy of the battery cell is released to the battery link through the isolated DC/DC converter.

3. The battery cell balance circuit as claimed in claim 1, wherein when the control unit detects that a battery voltage of any one of the battery cells is less than a lower threshold voltage, the control unit turns on the circuit switch and turns on the switch corresponding to the battery cell so that the battery cell receives the electrical energy from the AC power.

4. The battery cell balance circuit as claimed in claim 1, wherein the switches are electromagnetic relays,
a first positive end of each of the switches connected to a positive end of the DC power, and a first negative end of each of the switches connected to a negative end of the DC power,
a second positive end of each of the switches correspondingly connected to a positive end of the battery cell, and a second negative end of the switches correspondingly connected to a negative end of the battery cell.

5. The battery cell balance circuit as claimed in claim 1, wherein the switches comprise a plurality of switch units,
the positive end of each of the battery cells respectively connected to a first end of one switch unit, and second ends of the switch units jointly connected to a positive end of the DC power,
the negative end of each of the battery cells respectively connected to a first end of one switch unit, and second ends of the switch units jointly connected to a negative end of the DC power.

6. The battery cell balance circuit as claimed in claim 1, wherein the switches comprise a plurality of switch units and a switch assembly,
a positive end of a first battery cell of the battery cells connected to a first end of one switch unit, a negative end of a last battery cell of the battery cells connected to a first end of one switch unit, and the positive end and the negative end of the middle battery cells jointly connected to a first end of one switch unit,
the switch assembly comprises a plurality of switching switch units,
wherein second ends of the switch units are correspondingly connected to the switching switch units so that the positive ends of the battery cells are correspondingly connected to a positive end of the DC power and the negative ends of the battery cells are correspondingly connected to a negative end of the DC power.

7. The battery cell balance circuit as claimed in claim 1, wherein the AC/DC converter comprises an AC/DC conversion circuit and a non-isolated DC/DC conversion circuit.

8. The battery cell balance circuit as claimed in claim 7, wherein the non-isolated DC/DC conversion circuit is a buck conversion circuit comprising two switches and one inductor.

9. The battery cell balance circuit as claimed in claim 1, wherein the control unit comprises a battery charge control unit and a controller configured to control charging and discharging operations of the battery cells.

10. The battery cell balance circuit as claimed in claim 1, further comprising:
a plurality of over-current protection components correspondingly connected between the switches and the battery cells.

11. A method of operating a battery cell balance circuit, the battery cell balance circuit comprising a plurality of battery cells connected in series to form a battery link, a plurality of switches, each of the switches correspondingly connected to each of the battery cells, and a circuit switch coupled between a DC power and the switches, the method comprising steps of:
controlling the switch corresponding to the battery cell to be turned on when a battery voltage of any one of the battery cells is detected to be greater than an upper threshold voltage,
releasing electrical energy of the battery cell to the battery link,
controlling the circuit switch to be turned on and controlling the switch corresponding to the battery cell to be turned on when the battery voltage of any one of the battery cells is detected to be less than a lower threshold voltage, and
receiving, by the battery cell, the electrical energy from the DC power.

12. The method of operating the battery cell balance circuit as claimed in claim 11, wherein the battery cell balance circuit further comprises:
an isolated DC/DC converter, an input side of the isolated DC/DC converter coupled in parallel to an input side of each of the switches, and an output side of the isolated DC/DC converter coupled to the battery link,
wherein the electrical energy of the battery cell is released to the battery link through the isolated DC/DC converter.

13. The method of operating the battery cell balance circuit as claimed in claim 11, wherein the battery cell balance circuit further comprises:
an AC/DC converter, configured to receive an AC power and convert the AC power into the DC power,
wherein the circuit switch is coupled to the AC power through the AC/DC converter.

14. The method of operating the battery cell balance circuit as claimed in claim 11, wherein the switches are electromagnetic relays,
a first positive end of each of the switches connected to a positive end of the DC power, and a first negative end of each of the switches connected to a negative end of the DC power,
a second positive end of each of the switches correspondingly connected to a positive end of the battery cell, and a second negative end of the switches correspondingly connected to a negative end of the battery cell.

15. The method of operating the battery cell balance circuit as claimed in claim 11, wherein the switches comprise a plurality of switch units,
the positive end of each of the battery cells respectively connected to a first end of one switch unit, and second ends of the switch units jointly connected to a positive end of the DC power,
the negative end of each of the battery cells respectively connected to a first end of one switch unit, and second ends of the switch units jointly connected to a negative end of the DC power.

16. The method of operating the battery cell balance circuit as claimed in claim 11, wherein the switches comprise a plurality of switch units and a switch assembly,
a positive end of a first battery cell of the battery cells connected to a first end of one switch unit, a negative end of a last battery cell of the battery cells connected to a first end of one switch unit, and the positive end and the negative end of the middle battery cells jointly connected to a first end of one switch unit,
the switch assembly comprises a plurality of switching switch units,
wherein second ends of the switch units are correspondingly connected to the switching switch units so that the positive ends of the battery cells are correspondingly connected to a positive end of the DC power and the negative ends of the battery cells are correspondingly connected to a negative end of the DC power.
